(19) United States
(12) Patent Application Publication
(10) Pub. No.: US 2014/0165451 A1
(43) Pub. Date: Jun. 19, 2014

(54) Hands-Free Bait Storage and Retrieval Apparatus

(71) Applicant: Argie Scheibmeir, Yates Center, KS (US)

(72) Inventor: Argie Scheibmeir, Yates Center, KS (US)

(21) Appl. No.: 13/715,392

(22) Filed: Dec. 14, 2012

(51) Int. Cl. A01K 97/05

(52) U.S. Cl. CPC A01K 97/05
USPC 43/57; 43/55

(57) ABSTRACT

A hands-free bait storage and retrieval apparatus for use with a bucket having a continuous side wall defining an interior area and an open top includes a mounting frame having an upper ring and a plurality of mounting fasteners configured to selectively couple the upper ring to the bucket side wall such that the upper ring is situated in the bucket interior area and adjacent the open top thereof. A basket is selectively positioned in the bucket interior area. The apparatus includes a lifting assembly having a foot pedal and a linkage operatively coupling the foot pedal to the basket, the foot pedal being movable between a deployed configuration at which the basket is at a raised configuration within the bucket interior area and a released configuration at which the basket is at a lowered configuration within the bucket interior area.

### BACKGROUND OF THE INVENTION

This invention relates generally to bait containers and, more particularly, to a hands-free bait storage and retrieval apparatus that uses a foot pedal to lift fish bait out of the water in a bucket.

A popular form of fishing is setting trotlines along the banks of a river, baiting the hooks, and then checking them the next day to retrieve fish that may have been hooked. Bait may again be secured to the hooks, and so on. Catfish often feed overnight, making trotline fishing very successful. Baiting the hooks of one or more trotlines—sometimes called branch lines—requires the use of a boat and a sufficient quantity of live bait, such as minnows or other small fish that will be alluring to large catfish. The bait may be carried in a 5-gallon bucket and retrieved as needed to bait a trotline hook.

A difficulty of baiting hooks from a boat is the multi-tasking and awkwardness of the process. Specifically, the boat must be maneuvered adjacent the trotlines and a desired hook grasped with one hand while the lid to a bait bucket must be opened and live bait swimming inside must be retrieved with the other hand. In this way, the excitement of trotline fishing may become frustrating when the live bait is difficult to grasp or the lack of hands leads to the bait bucket tipping over.

Therefore, it would be desirable to have a bait storage and retrieval apparatus for holding live bait for trotlines and that provides hands-free access to the container. Further, it would be desirable to have a bait apparatus that normally keeps live bait submerged in water and that raises it above the water when a foot pedal is actuated.

### SUMMARY OF THE INVENTION

A hands-free bait storage and retrieval apparatus according to the present invention for use with a bucket having a continuous side wall defining an interior area and an open top includes a mounting frame having an upper ring and a plurality of mounting fasteners configured to selectively couple the upper ring to the bucket side wall such that the upper ring is situated in the bucket interior area and adjacent the open top thereof. A basket is selectively positioned in the bucket interior area. The apparatus includes a lifting assembly having a foot pedal and a linkage operatively coupling the foot pedal to the basket, the foot pedal being movable between a deployed configuration at which the basket is at a raised configuration within the bucket interior area and a released configuration at which the basket is at a lowered configuration within the bucket interior area.

Therefore, a general object of this invention is to provide a bait storage and retrieval apparatus that maintains bait submerged in water in a bucket until needed and then raises the bait out of the water when a foot pedal is actuated so that the bait may be retrieved by a user.

Another object of this invention is to provide an apparatus, as aforesaid, that includes a basket situated in a bucket that may be selectively raised and lowered by operation of the foot pedal.

Still another object of this invention is to provide an apparatus, as aforesaid, in which the basket is porous so as to permit water to empty therethrough when the basket is raised above the water level such that the live bait may be caught easily by a fisherman.

Yet another object of this invention is to provide an apparatus, as aforesaid, that is easy to use and inexpensive to produce.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a hands-free bait storage and retrieval apparatus according to one embodiment of the present invention in a substantially closed configuration;

FIG. 2a is a perspective view of the apparatus as in FIG. 1 in an open configuration;

FIG. 2b is an isolated view on an enlarged scale taken from FIG. 2a;

FIG. 3 is an exploded view of the apparatus as in FIG. 1;

FIG. 4a is a side view of the apparatus as in FIG. 1;

FIG. 4b is a side view of the apparatus as in FIG. 2;

FIG. 5a is a side view from another angle of the apparatus as in FIG. 4a;

FIG. 5b is a side view from another angle of the apparatus as in FIG. 4b;

FIG. 6a is a perspective view of the apparatus as in FIG. 1 with the bucket removed for clarity;

FIG. 6b is a perspective view of the apparatus as in FIG. 2 with the bucket removed for clarity; and

FIG. 7a is a side view of the apparatus as in FIG. 6a according to another embodiment of the present invention, illustrated in a released configuration; and

FIG. 7b is a side view of the apparatus as in FIG. 7a illustrated in a raised configuration.

### DESCRIPTION OF THE PREFERRED EMBODIMENT

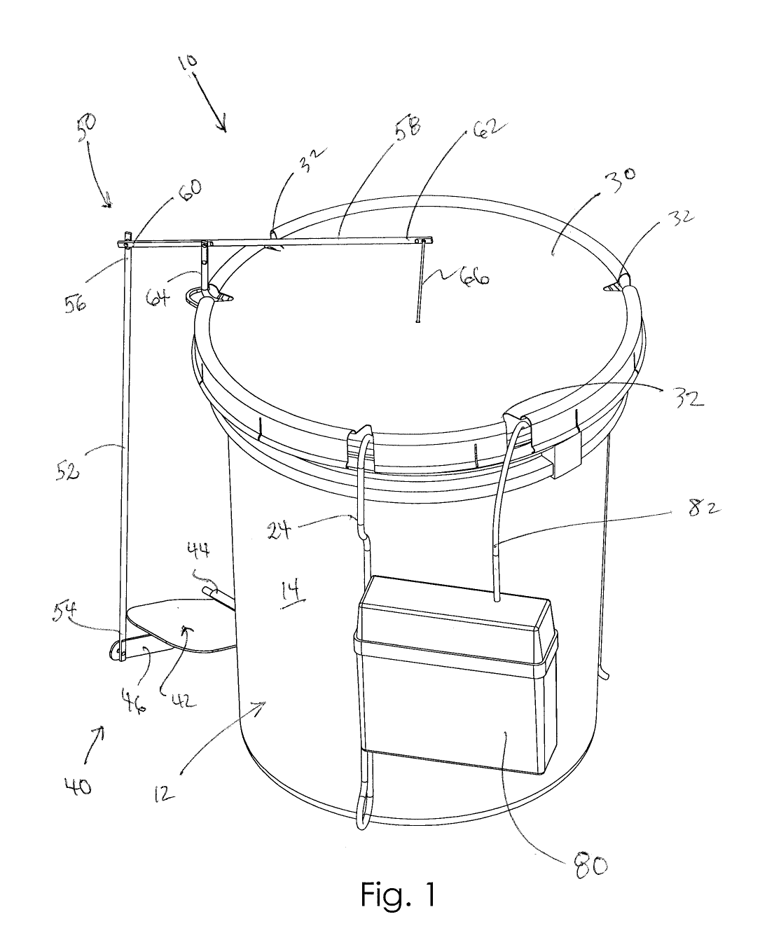

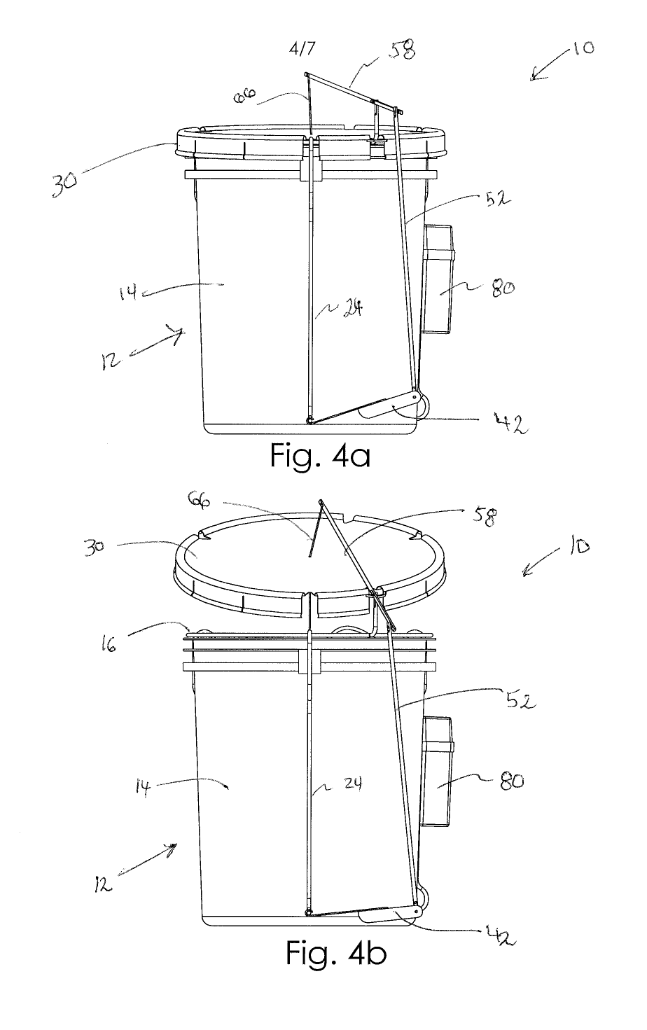

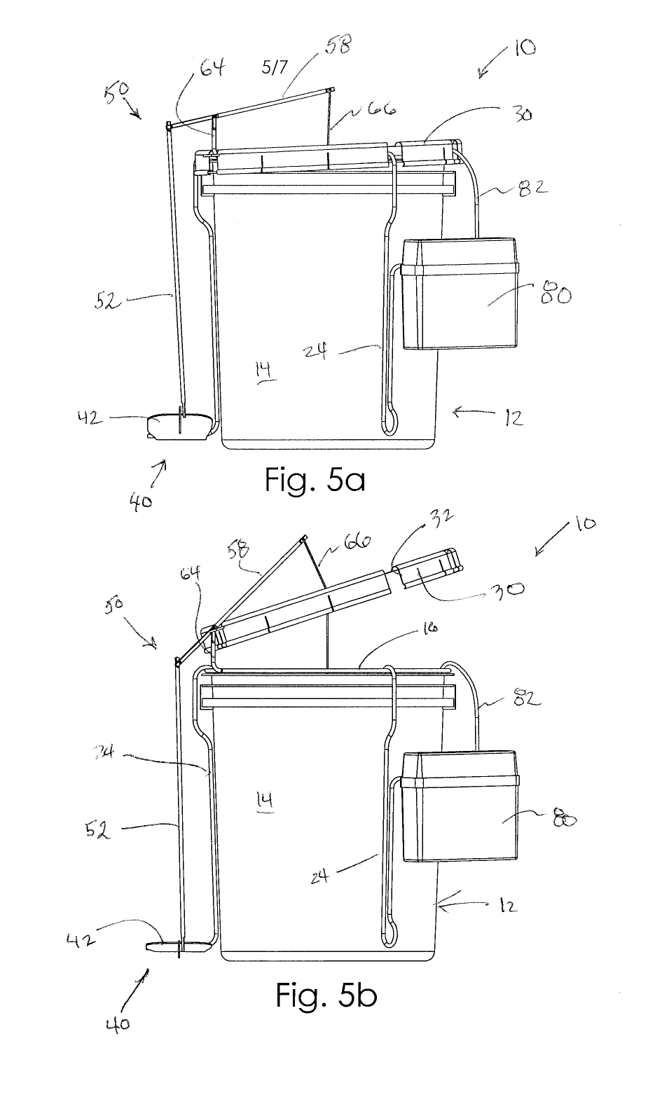

A hands-free bait storage and retrieval apparatus according to a preferred embodiment of the present invention will now be described with reference to FIGS. 1 to 7b of the accompanying drawings. The bait storage and retrieval apparatus 10 includes a mounting frame 20, a basket 70, and a lifting assembly 40 configured to selectively raise and lower the basket 70. The present invention is preferably for use with a 5-gallon bucket 12 of the type having a closed bottom and an upstanding continuous side wall 14 extending upwardly from the closed bottom, the side wall having an upper edge 16 defining an open top. The bait storage apparatus 10, therefore, may be sold with or without the bucket 12. The bucket 12 defines an interior area configured to contain water, fish bait, and the mounting frame 20.

The mounting frame 20 includes an upper ring 22 having a generally circular configuration having a diameter complementary to an inner diameter of the bucket 12 so as to be positioned in the interior area of the bucket 12. The upper ring 22 may be constructed out of metal although a plastic construction may also work. The mounting frame 20 may also include a plurality of fasteners 24 configured to selectively couple the upper ring 22 to the side wall 14 of the bucket 12. Each fastener 24 may include a generally inverted U-shaped configuration having an inner portion 26 integrally connected to an outer portion 28 so as to define an open bottom and a closed top portion 29. Accordingly, a fastener 24 may be a clip configured such that an inner portion 26 captures the upper ring 22 against an inside surface of the side wall 14 of the bucket 12 and that an outer portion 28 is situated against an outer surface of the side wall 14 of the bucket 12. As shown in the drawings, each fastener 24 may have an elongate configuration so that the closed top portion 29 may rest against the upper edge 16 of the bucket side wall 14 and the inner portion 26 and outer portion 28 thereof extend substantially to the bucket bottom wall. Alternatively, however, each fastener 24 may include inner and outer portions that are considerably shorter.

The mounting frame 20 may also include a lid 30 having a diameter and configuration that is complementary to the upper edge 16 of the bucket 12 so as to be selectively coupled thereto. A peripheral edge of the lid 30 may define a plurality of notches 32 configured to allow respective fasteners 24 to be inserted therethrough when coupling the upper ring 22 to a bucket 12. The lid 30 may be pivotally coupled to the linkage 50 and movable between an open configuration providing access to the bucket interior area and a closed configuration preventing access to the bucket interior area, as will be described in more detail later.

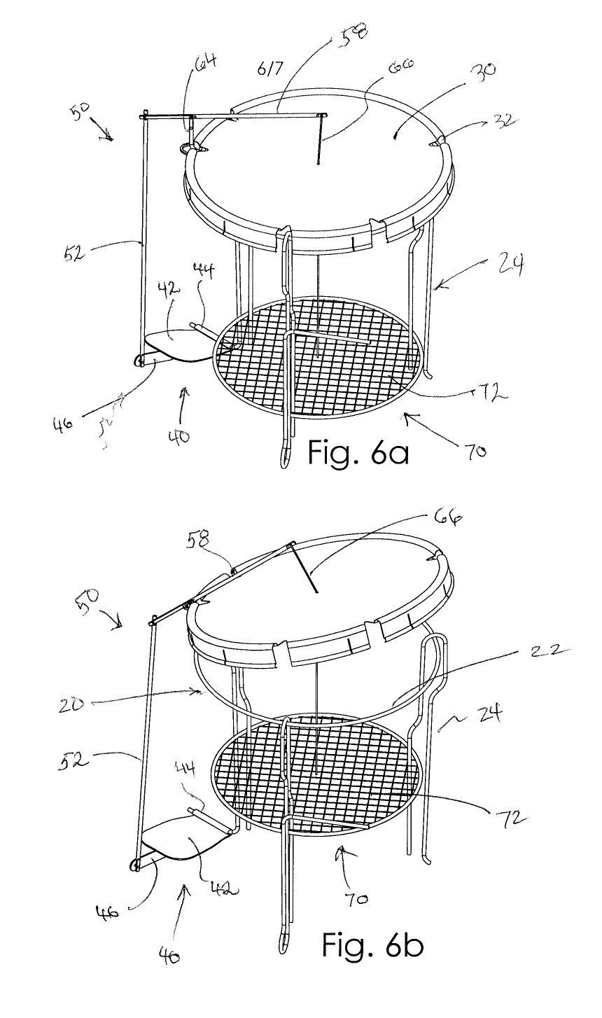

The basket 70 may be selectively positioned in the interior area of the bucket 12. The construction of the basket 70 will be described in more detail later. The lifting assembly 40 includes a foot pedal 42 and a linkage 50 operatively coupling the foot pedal 42 to the basket 70 such that operation of the foot pedal 42 causes the basket 70 to be moved between a raised configuration (FIG. 6a) and a released configuration (FIG. 6a). The foot pedal 42 is normally biased toward the released configuration, such as by a spring hinge 44. More particularly, the linkage 50 may include a pedal extension member 46 coupled to the foot pedal 42 and extending forwardly (FIG. 6b).

The linkage 50 also includes first rod 52 having a lower end 54 coupled to the pedal extension member 46 and, therefore, operatively coupled to the foot pedal 42. The first rod 52 includes an upper end 56 opposite the lower end 54 and extends upwardly and vertically, the first rod 52 having a linear configuration. The first rod 52 moves in direct relation to movement of the foot pedal 42. In other words, the first rod 52 moves upwardly when the foot pedal 42 is moved upwardly and moves downwardly when the foot pedal 42 is moved downwardly. The first rod lower end 54 may be pivotally coupled to the foot pedal extension member 46 such that the first rod 52 maintains a perfectly vertical orientation as the foot pedal 42 is moved upwardly or downwardly.

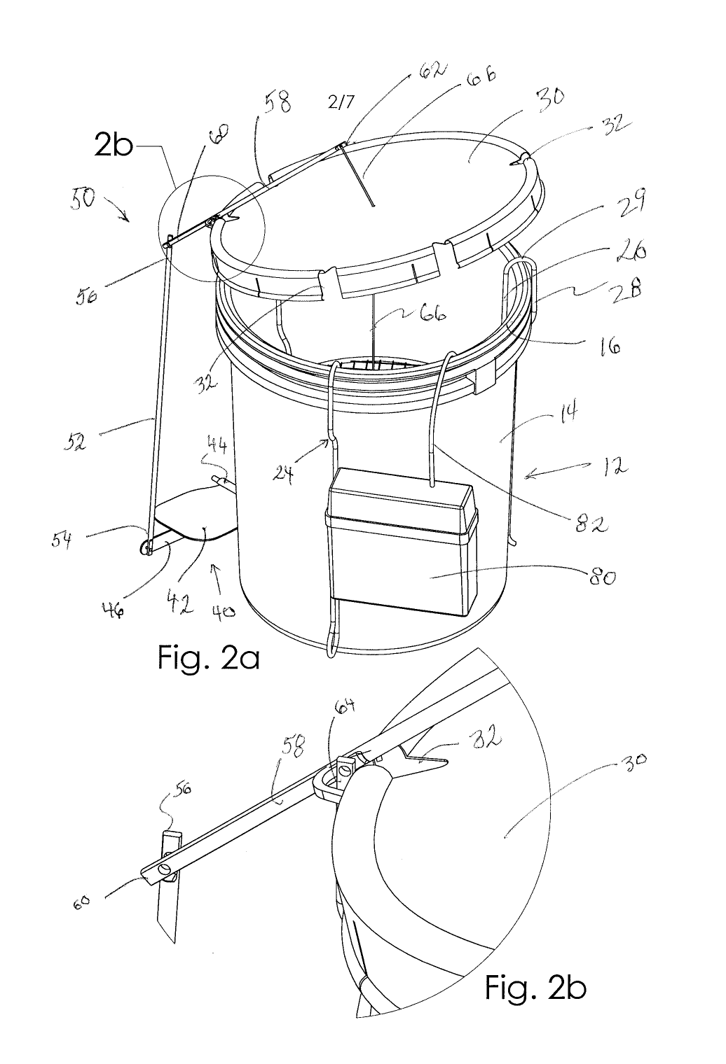

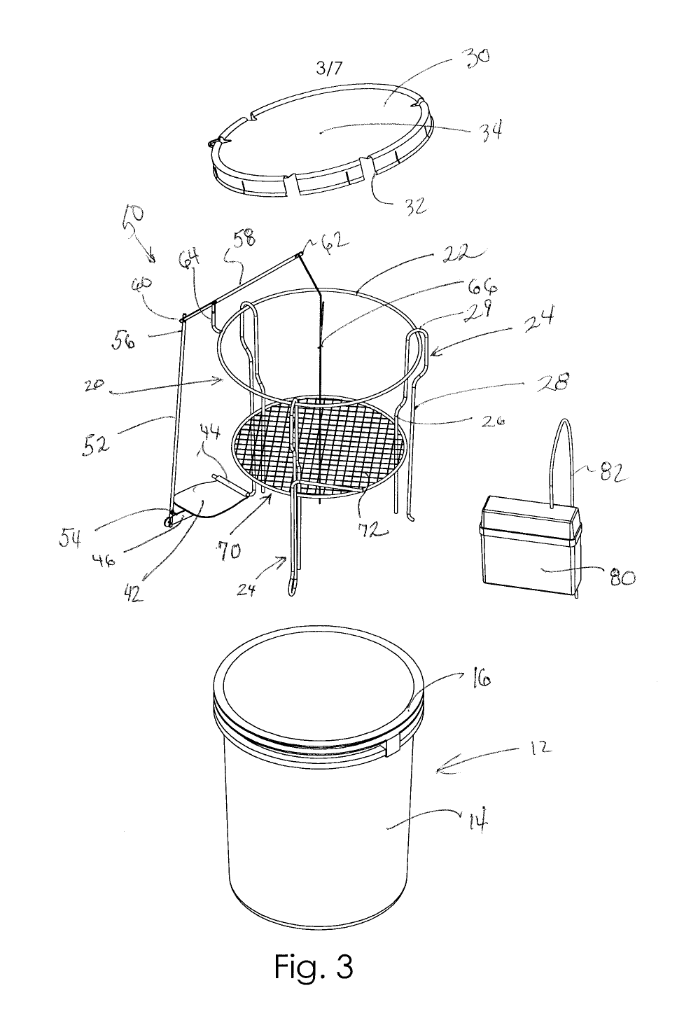

The linkage 50 includes a second rod 58 having a first end 60 pivotally coupled to the upper end 56 of the first rod 52. The second rod 58 includes a second end 62 opposite the second rod first end 60 and includes a generally linear configuration. The linkage 50 includes a support member 64 having a lower end coupled to the upper ring 22 of the mounting frame 20 and extending upwardly, the support member 64 being positioned adjacent to a peripheral edge of the lid 30 so as not to interfere with movement of the lid 30 (FIGS. 2b and 3). The support member 64 includes an upper end pivotally coupled to the second rod 58. The support member 64 is positioned to serve as a fulcrum over which the second rod 58 may pivot, the result of which is that movement of the second end 62 of the second rod 58 is inverse to movement of the foot pedal 42. In one embodiment, the lid 30 may be coupled to the support member 64 (FIG. 2b).

The linkage 50 further includes a cord 66 coupled at one end to the second end 62 of the second rod 58 and at another end to the basket 70 so that the basket 70 is lifted upwardly toward the upper ring 22 of the mounting assembly 40 (i.e. to the raised configuration) when the foot pedal 42 is pressed downwardly to the deployed configuration (FIGS. 3 and 6b). The lid 30 defines an aperture 34 through which the cord 66 may pass between the second end 62 of the second rod 58 and the basket 70. It is understood that the lifting assembly 40 may include a flange (not shown) connected to the cord 66 adjacent a lower surface of the lid 30 that causes the entire lid 30 to be lifted upwardly when the cord 66 is pulled upwardly by operation of the second rod 58. The flange includes a diameter larger than a diameter of the aperture 34. In other words, the cord 66 does not merely slide through the aperture 34 but urges the lid to the open configuration when the cord 66 is lifted upwardly by the second rod 58.

The basket 70 may include a bottom portion 72 having a porous configuration through which water may pass through easily but which solid objects, such as fish or other bait, are prevented from passing. For instance, when the basket 70 is lifted upwardly out of water in the bucket, the water passes through the basket bottom portion 72 while the bait remain on the basket bottom portion 72 and are easily retrieved by a fisherman The basket bottom portion 72 may be constructed of a net, mesh, grate, or other porous material.

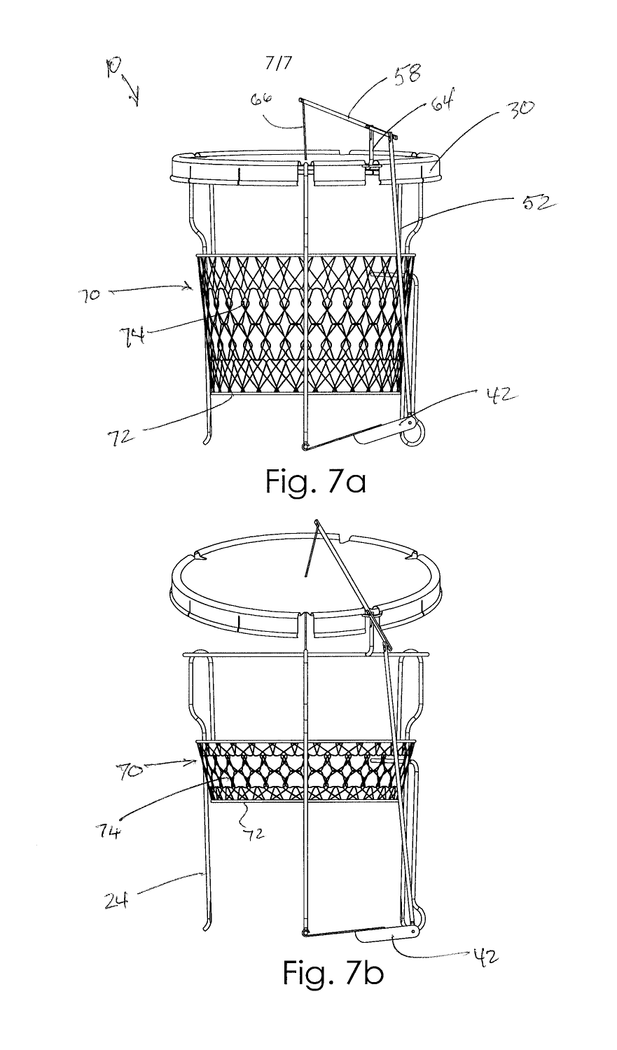

Turning to FIGS. 7a and 7b, another embodiment of the basket 70 may further include a continuous wall portion 74 having a lower edge coupled to a peripheral edge of the bottom portion 72 and an upper edge coupled to the upper ring 22 of the mounting frame 20. The wall portion 74 has a flexible construction that folds up or collapses together as the basket bottom portion 72 is raised upon operation of the linkage described above. The wall portion 74 may be constructed of a net, mesh, or grate material that is porous so as to enable water to pass therethrough as the basket bottom portion 72 is moved to the raised configuration. The wall portion 74 is especially effective in preventing live bait from passing to the side of the bottom portion 72 and escaping retrieval by a user at the raised configuration.

The apparatus 10 may also include an oxygen infusion device 80 that may be coupled to the bucket 12 or to a fastener 24. The oxygen infusion device 80 may include a hose 82 that may be situated in the bucket interior area and in the water therein. The oxygen infusion device 80 generates oxygen so that the live bait may maintain necessary oxygenation.

In use, the hands-free bait storage and retrieval apparatus 10 may be coupled to a bucket 12 as described above and the bucket 12 may be partially filled with water. Live bait, such as minnows or other small fish, may be deposited into the water so as to keep the bait alive. The lid 30 may be closed so as to enclose the bait and to prevent an inadvertent spilling of the water. The bucket 12 and apparatus 10 may then be transported by a fisherman in a boat while baiting hooks on one or more trotlines. When approaching a hook, the fisherman may depress the foot pedal using his foot which causes the linkage to urge the lid 30 to the open configuration and the basket 70 to the raised configuration as described above. With the lid 30 is open and the basket 70 is raised above the water level in the bucket 12, the live bait is unable to swim and the fisherman may retrieve a selected fish with one hand and secure it to a hook of the trotline. The fisherman may then release the foot pedal which causes the basket 70 of live bait to submerge into the water.

It is understood that while certain forms of this invention have been illustrated and described, it is not limited thereto except insofar as such limitations are included in the following claims and allowable functional equivalents thereof.

1. A bait storage and retrieval apparatus for use with a bucket having a continuous side wall defining an interior area and an open top, comprising:
a mounting frame having an upper ring and a plurality of mounting fasteners configured to selectively couple said upper ring to the bucket side wall such that said upper ring is situated in the bucket interior area and adjacent the open top thereof;
a basket selectively positioned in the bucket interior area;
a lifting assembly having a foot pedal and a linkage operatively coupling said foot pedal to said basket, said foot pedal being movable between a deployed configuration at which said basket is at a raised configuration within the bucket interior area and a released configuration at which said basket is at a lowered configuration within the bucket interior area.

2. The apparatus as in claim 1, wherein said mounting framework includes a lid having a configuration complementary to the open end of the bucket, said lid being pivotally coupled to said framework so as to be selectively movable between an open configuration providing access to the bucket interior area and a closed configuration preventing access to the bucket interior area.

3. The apparatus as in claim 2, wherein said linkage includes:
a first rod having a lower end operatively connected to said foot pedal and an opposed upper end, said first rod configured to move vertically in the same direction as movement of said foot pedal;
a second rod having a first end pivotally coupled to said first rod upper end and an opposed second end; and
a support member having a lower end coupled to said upper ring of said mounting frame and extending upwardly and an opposed upper end pivotally coupled to said second rod, wherein said support member upper end is a fulcrum for pivotal movement of said second rod such that movement of said second rod second end is inverse to movement of said foot pedal.

4. The apparatus as in claim 3, wherein said lifting assembly includes a cord coupled to said second rod second end and to said basket such that said basket is lifted upwardly toward said upper ring when said foot pedal is moved to said deployed configuration.

5. The apparatus as in claim 4, wherein said lid defines an aperture through which said cord extends between said second rod second end and said basket.

6. The apparatus as in claim 5, wherein said lifting assembly includes a cord flange connected to said cord adjacent a lower surface of said lid at said aperture, said flange having a diameter larger than a diameter of said aperture, wherein said lid is urged toward said open configuration when said second rod second end is moved upwardly.

7. The apparatus as in claim 1, wherein each said mounting fastener includes:
an inner portion coupled to an outer portion and having a generally inverted u-shaped configuration defining an open bottom such that said inner portion captures said upper ring to an inner surface of the bucket and said outer portion is situated against an outer surface of the bucket.

8. The apparatus as in claim 1, wherein said foot pedal is normally biased toward said released configuration.

9. The apparatus as in claim 1, wherein said basket includes a bottom portion having a porous configuration through which water passes easily but through which fish bait cannot pass.

10. The apparatus as in claim 9, wherein said bottom portion of said basket is one of a net, a mesh and a grate.

11. The apparatus as in claim 9, wherein said basket includes a continuous wall portion having a lower edge coupled to a peripheral edge of said bottom portion and an upper edge coupled to said upper ring of said mounting framework, said wall portion having a porous configuration through which water passes easily but through which fish bait cannot pass.

12. The apparatus as in claim 11, wherein said wall portion of said basket is one of a net, a mesh and a grate.

13. The apparatus as in claim 11, wherein said wall portion of said basket is one of a net, a mesh and a grate.

14. The apparatus as in claim 6, further comprising an oxygen infusion device in fluid communication with the interior space of the bucket such that oxygen is infused into water in the bucket.

15. The apparatus as in claim 1, further comprising an oxygen infusion device in fluid communication with the interior space of the bucket such that oxygen is infused into water in the bucket.
